(19) United States
(12) Patent Application Publication
(10) Pub. No.: US 2006/0223455 A1
(43) Pub. Date: Oct. 5, 2006

(54) System and method for wireless communication using low-pulling digital interface signals

(75) Inventor: Donald A. Kerth, Austin, TX (US)

Correspondence Address: MARK P. KAHLER, 8101 VAILVIEW COVE, AUSTIN, TX, 78750-7881, US

(73) Assignee: SILICON LABORATORIES INC., Austin, TX (US)

(21) Appl. No.: 11/096,130

(22) Filed: Mar. 31, 2005

(51) Int. Cl. H04B 1/40

(52) U.S. Cl. 455/76; 455/86

(57) ABSTRACT

The digital interface between the baseband section and the RF transceiver section of a wireless communication device may cause undesired pulling to an impedance sensitive portion of the RF transceiver section. In one embodiment, an original interface signal that exhibits a duty cycle is modified by an interface control block in the baseband section. The resultant modified interface signal exhibits a duty cycle less than the duty cycle of the original interface signal. In this manner, when the modified interface signal is applied to the RF transceiver section, less pulling of the impedance sensitive portion occurs than if the original interface signal were applied directly to the RF transceiver section.

### TECHNICAL FIELD OF THE INVENTION

The disclosures herein relate generally to interfacing electrical circuits with one another, and more particularly to interfacing electrical circuits in wireless communication systems.

### BACKGROUND

Modern wireless communication devices can generally be partitioned into a baseband section and an RF transceiver section. In broad terms, when the wireless device operates in transmit mode, the baseband section processes signals before they are modulated for transmission by the RF transceiver section at a higher frequency than employed in the baseband section. When the wireless device operates in receive mode, the baseband section processes signals after they have been down-converted and demodulated by the RF transceiver section. The baseband section and the RF transceiver section can be fabricated on separate integrated circuits (IC's) that are interfaced with one another.

The RF transceiver section typically includes a frequency synthesizer to enable the wireless device to tune among the many channels on which it is able to communicate. Frequency synthesizers generally employ a phase locked-loop (PLL) together with divider and phase detector circuitry to enable the wireless device to switch from channel to channel. PLL circuits include voltage controlled oscillators (VCOs) that are controlled via feedback and an error signal to produce the desired output frequency (fₒᵤₜ). The VCO includes a VCO tank circuit which may be thought of as an inductor and capacitor in parallel. It has been found that the VCO tank circuit can be susceptible to a phenomenon referred to as “frequency pulling” wherein signals driving the inputs of the RF transceiver section are undesirably coupled to, and load down, the VCO tank circuit. This can cause the operating frequency of the VCO to change from its intended operating frequency.

Integrating the VCO and PLL together on the same synthesizer IC or transceiver IC can result and spur problems and pulling problems. Replica circuitry can be used to reduce pulling that is caused “on-chip”, i.e. caused be operating conditions within the IC. Replica circuitry helps minimize on-chip pulling by maintaining a more constant impedance environment near the circuitry that is replicated as seen by adjacent components. Moreover, RC filters have been employed at the clock input of a synthesizer IC to reduce pulling that would otherwise be caused by the changing impedance state resulting from the clock signal as it changes state from high to low and low to high. It is also known to reduce the duty cycle of on-chip signals to reduce pulling on-chip, for example on a synthesizer chip or transceiver chip.

The recently proposed DigRF Digital Interface Specification describes a standard digital interface between the baseband section and the RF transceiver section of a wireless communication device. DigRF is a trademark of the Digital Interface Working Group. In such a digital interface wherein digital signals from the baseband section drive the RF transceiver section, the changing state from high to low or low to high of these digital signals at the interface can present a changing impedance environment to the VCO tank circuit in the RF transceiver section. This may cause the open loop operating frequency of the frequency synthesizer to be “pulled” or changed to a value other than the intended open loop operating frequency. Such “pulling” can occur due to undesired mutual coupling between the inputs of the RF transceiver section and the VCO tank circuit as well as changing capacitance in the RF transceiver section. More particularly, undesired pulling can result from a change in the input capacitance of the RF transceiver section when an input voltage changes state from low to high or high to low.

What is needed is a wireless communication device with a digital interface between the baseband section and the RF transceiver section that reduces the undesirable pulling effects caused by off-chip signals, i.e. signals at the digital interface.

### SUMMARY

Accordingly, in one embodiment, a method is disclosed for operating a wireless communication device including a baseband IC and a radio frequency (RF) IC. The method includes coupling, by a digital interface, the baseband IC to the RF IC. The method also includes sending, by the baseband IC, a low duty cycle signal across the digital interface to the RF IC, such that low pulling of an impedance sensitive portion of the RF IC is achieved. In another embodiment, an interface signal is supplied to the digital interface, wherein the interface signal exhibits a switched state that is sufficiently short in time that significant pulling of an impedance sensitive portion of the RF IC is avoided.

In another embodiment, a method is disclosed for operating a wireless communication device including a baseband IC and a radio frequency (RF) IC. The method includes coupling, by a digital interface, the RF IC to the baseband IC. The method further includes sending, by the RF IC, a low duty cycle signal across the digital interface to the baseband IC, such that low pulling of an impedance sensitive portion of the RF IC is achieved.

In yet another embodiment, a wireless communication device is disclosed that includes a baseband section and a radio frequency (RF) section. The RF section includes an impedance sensitive portion. The device also includes a digital interface that couples the baseband section to the RF section. The baseband section sends a low duty cycle signal across the digital interface to the RF section such that low pulling of the impedance sensitive portion in the RF section is achieved.

In still another embodiment, a wireless communication device is disclosed that includes a baseband section and a radio frequency (RF) section. The RF section includes an impedance sensitive portion. The device also includes a digital interface that couples the baseband section to the RF section. The RF section sends a low duty cycle signal across the digital interface to the baseband section such that low pulling of the impedance sensitive portion in the RF section is achieved.

In yet another embodiment, a wireless communication device is disclosed that includes a baseband integrated circuit (IC). The device also includes a radio frequency (RF) IC including impedance sensitive RF circuitry. The device further includes a digital interface, external to the baseband IC and the RF IC, that couples the baseband IC to the RF IC. The baseband section sends a low duty cycle signal across the digital interface to the RF IC such that low pulling of the impedance sensitive RF circuitry is achieved.

### BRIEF DESCRIPTION OF THE DRAWINGS

The appended drawings illustrate only exemplary embodiments of the invention and therefore do not limit its scope, because the inventive concepts lend themselves to other equally effective embodiments.

FIG. 1A is a representation of a conventional wireless communication device wherein digital interface signals cause undesired frequency pulling.

FIG. 1B is a graph of signals in the transmit stream of the digital interface of FIG. 1A

FIG. 1C is a graph of signals in the receive stream of the digital interface of FIG. 1A

FIG. 2 is a graph of a receive-transmit enable (RXTXEN) signal that exhibits a 50% duty cycle in the digital interface of FIG. 1A. VCO frequency and VCO phase are shown to illustrate the frequency problem experienced due to the digital interface of FIG. 1A.

FIG. 3 is a block diagram of the disclosed wireless communication device.

FIG. 4A shows representative transmit stream waveforms that demonstrate modification of the RXTXEN enable signal and the RXTXDATA signal to reduce pulling of VCO frequency.

FIG. 4B shows representative receive stream waveforms that demonstrate modification of the RXTXEN enable signal to reduce pulling of the VCO frequency.

FIG. 5 shows the low pulling RXTXEN′ waveform, the VCO frequency waveform and the VCO phase waveform of the disclosed wireless communication device.

FIG. 6A is a schematic diagram of a logic circuit that can be employed to convert a signal to a low pulling interface signal.

FIG. 6B shows RXTXEN, CLK, /Q and RXTXEN′ waveforms that demonstrate the operation of the logic circuit of FIG. 6A.

FIG. 7 is a flowchart depicting a method of operating the disclosed wireless communication system in a transmit mode.

FIG. 8 is a flowchart depicting a method of operating the disclosed wireless communication system in a receive mode.

### DETAILED DESCRIPTION

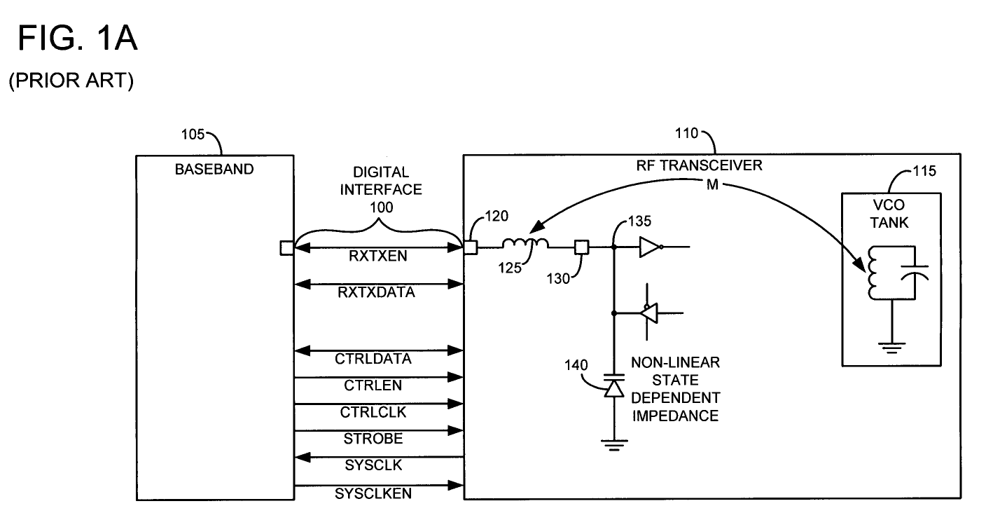

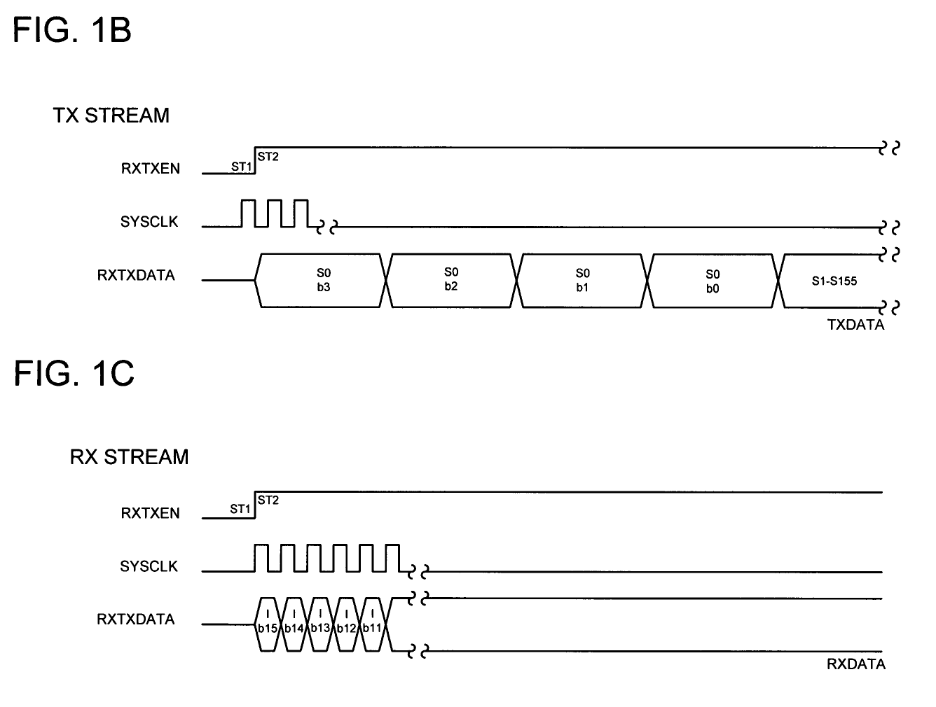

FIG. 1A is a block diagram that illustrates a DigRF digital baseband/RF interface 100 that exhibits the pulling problem discussed above. Digital interface 100 is used to communicate information between baseband section 105 and RF transceiver section 110. As shown in FIG. 1A, digital interface 100 includes eight lines, namely RXTXEN, RXTXDATA, CTRLDATA, CTRLEN, CTRLCLK, STROBE, SYSCLK AND SYSCLKEN. Transmit data and receive data streams are multiplexed on the RXTXDATA line.

FIG. 1B shows representative waveforms associated with a transmit data stream (TX STREAM) including the RXTXDATA data line of digital interface 100 when baseband section 105 sends data to RF transceiver section 110. More particularly, FIG. 1B shows a receive-transmit enable signal, RXTXEN, a system clock signal, SYSCLK, along with the actual transmitted data signal, RXTXDATA which is streamed from baseband section 105 to RF transceiver section 110.

FIG. 1C shows representative waveforms associated with a receive data stream (RX STREAM) including the RXTXDATA data line of digital interface 100 when baseband section 105 receives data from RF transceiver section 110. More specifically, FIG. 1C shows the receive-transmit enable signal, RXTXEN, the system clock signal, SYSCLK, along with the actual received data signal, RXTXDATA which is streamed from the RF transceiver section 110 to the baseband section 105.

When one or more of the eight lines of digital interface 100 transitions from low to high or high to low, this action can cause a corresponding change in the internal impedance environment of RF transceiver 110 which is illustrated in FIG. 1A. This may cause undesired frequency pulling in circuits internal to RF transceiver 110. To further illustrate the problem, RF transceiver 110 is shown as including a resonant structure, namely inductor-capacitor (LC) tank circuit 115 which is also referred to as VCO tank circuit 115. This resonant structure is susceptible to pulling by digital signals on the interface inputs of RF transceiver 110, such as the RXTXEN interface input pin 120, for example. Such an inductor-capacitor tank circuit 115 is typically found in the VCO of a frequency synthesizer (not shown) in RF transceiver section 110. For example purposes, the frequency pulling problem is discussed with respect to the RXTXEN input, namely input pin 120, of the digital interface 100 that is coupled to RF transceiver 110. In this example, it is assumed that RF transceiver section 110 is implemented on an integrated circuit (IC) chip and that input pin 120 is located off-chip. Input pin 120 may also be referred to as an off-chip pad 120. Input pin 120 is coupled by a bond wire 125 to an on-chip pad 130, namely a pad situated on the chip on which RF transceiver 110 is formed. Bond wire 125 is represented as an inductor to denote the effective inductance that it exhibits. On-chip pad 130 is coupled to a node 135 as illustrated in FIG. 1A.

In the circuit arrangement of FIG. 1A, a nonlinear state dependent impedance 140 is effectively coupled between node 135 and ground as shown. Impedance 140 is represented as a varactor diode to denote that the capacitive reactance of impedance 140 varies with the voltage present at node 135 and hence also varies with the voltage at input pin 120. In a practical RF transceiver, there will also be some amount of mutual inductance, M, between bond wire 125 and tank circuit 115. Thus, voltage changes at the input pin 120 of digital interface 100 may result in impedance 140 and inductor 125 presenting a changing impedance environment to tank circuit 115. This changing impedance environment can undesirably shift or pull the operating frequency of a resonant structure such as tank circuit 115.

For example, when the RXTXEN (receive/transmit enable) signal of the transmit stream of FIG. 1B transitions from a logic low (state ST1) to a logic high (state ST2) to enable transmission of an RXTXDATA data stream to RF transceiver 110, this transition presents just such a change of voltage which can pull the operating open loop frequency of tank circuit 115. Likewise, such an operating frequency pull can occur when the RXTXEN (receive/transmit enable) signal of the receive stream of FIG. 1C changes state to enable reception of an RXTXDATA data stream. While the pulling problem has been described with respect to the RXTXEN line of the digital interface 100, pulling problems can also be caused by signals changing state on the other lines or pins of the interface 100 as well.

In FIG. 1B, the RXTXDATA data signal of the transmit stream includes 4 bits per symbol. For example, symbol S0 includes bits, b0, b1, b2 and b3. In FIG. 1C the RXTXDATA data signal of the receive stream includes I and Q values of which the I values are illustrated. Bits b11-b15 are bits of the received RXTXDATA signal.

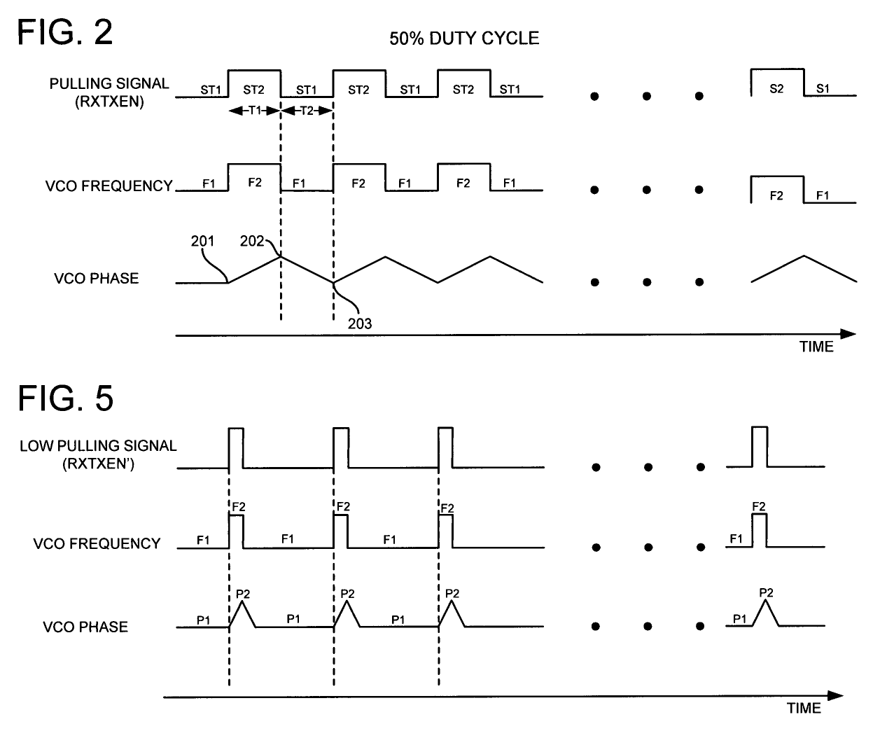

FIG. 2 shows a 50% duty cycle pulling signal (RXTXEN), namely the receive-transmit enable signal, which can produce a substantial amount of undesired pulling of the VCO frequency. This pulling signal is one of the interface signals of digital interface 100. In this example, the RXTXEN signal exhibits a logic low state, ST1, followed by a logic high state, ST2, followed then by another logic low state, ST1, etc., all being of equal time duration. T1 is the time duration of the ST2 state while T2 is the time duration of the ST1 state. Since in this example times T1 and T2 are equal, the RXTXEN signal exhibits a 50% duty cycle wherein the RXTXEN enable signal is high the same amount of time that it is low. It was found that the maximum amount of undesirable pulling occurs when the pulling signal exhibits a 50% duty cycle. The pulling problem can be appreciated by observing the VCO frequency which is plotted immediately below the RXTXEN signal in FIG. 2. When the RXTXEN signal exhibits a logic low, ST1, then the VCO frequency is some frequency, F1. However, when the RXTXEN signal changes to the logic high state, ST2, i.e. the enable signal goes high, then the VCO frequency shifts to a different frequency, F2, by virtue of the pulling effect described above. The VCO phase is plotted immediately below the VCO frequency signal in FIG. 2. VCO phase is the integration of the VCO frequency. When the RXTXEN enable signal goes from the ST1 state to the ST2 state, not only is the VCO frequency pulled from F1 to F2, but the VCO phase also starts increasing at 201 and continues increasing through the duration T1 of the ST2 logic high state as seen in FIG. 2. The VCO phase continues to increase until the end of the ST2 logic state which corresponds to the VCO phase peak at 202. At 202 the pulling signal, RXTXEN, returns to a logic low state, ST1, and the VCO phase decreases until the end of logic states ST1 which corresponds to 203 as illustrated.

By changing the duty cycle of the pulling signal at interface 100, the undesired pulling effect on the VCO frequency and VCO phase can be reduced. Stated alternatively, if the duration of logic state ST2 is decreased with respect to the duration of logic state ST1, then the VCO frequency shift occurs for a smaller period of time. Thus, the time during which the VCO is exposed to a different impedance is decreased. Moreover the peak at 202 of the VCO phase is made desirably smaller as well.

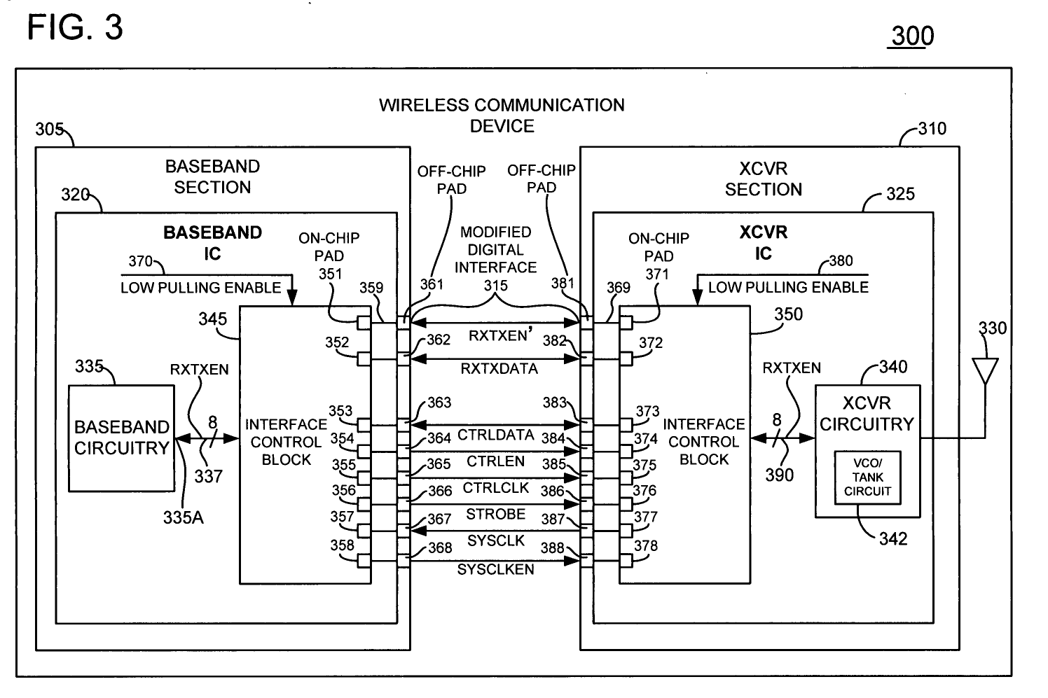

FIG. 3 shows a wireless communication device 300 which uses this reduced duty cycle technique to decrease the undesired pulling effect that digital interface signals can have on circuits coupled to a digital interface. More particularly, wireless communication device 300 includes a baseband section 305 which is interfaced with an RF transceiver (XCVR) section 310 by a digital interface 315 therebetween. Baseband section 305 includes a baseband integrated circuit (IC) 320 that is coupled to a modified digital interface 315. XCVR section 310 includes an RF XCVR IC 325 that is coupled to the modified digital interface 315 and to an antenna 330. In this particular embodiment, baseband IC 320 includes baseband circuitry 335 and RF XCVR IC 325 includes XCVR circuitry 340. Both baseband circuitry 335 and XCVR circuitry 340 are compatible with the DigRF standard. The DigRF Baseband/RF Digital Interface Specification is incorporated herein by reference in its entirety. DigRF is a trademark of the Digital Interface Working Group. The DigRF interface standard specifies an 8 line interface including the following lines/signals: RXTXEN, RXTXDATA, CTRLDATA, CTRLEN, CTRLCLK, STROBE, SYSCLK, and SYSCLKEN. The RXTXDATA line carries streaming data bidirectionally across the interface and the RXTXEN enable line carries the enable signal which enables the interface for such streaming communication in one direction or the other.

An example is now provided wherein baseband section 305 supplies a transmit stream to XCVR section 310 and XCVR section 310 transmits that transmit stream. In more detail, baseband circuitry 335 includes an 8 line I/O port 335A including DigRF lines RXTXEN, RXTXDATA, CTRLDATA, CTRLEN, CTRLCLK, STROBE, SYSCLK, and SYSCLKEN of which the RXTXEN line is shown in FIG. 3. Eight line I/O port 335A is coupled to an 8 line bus 337 of which the RXTXEN line is specifically shown. Baseband IC 320 includes an interface control block 345 coupled between baseband circuitry 335 and modified digital interface 315. Interface control block 345 intercepts the signals on the lines of bus 337 and modifies one or more of these signals in accordance with the disclosed low pulling technology before passing these modified signals to modified digital interface 315. For example purposes, a modification of the RXTXEN enable signal will be discussed below although the same technique can be applied to other lines of bus 337 as well to lessen pulling problems that may be associated with those lines. The duty cycle of the RXTXEN signal is modified by interface control block 345 to provide an RXTXEN′ signal that, when presented to XCVR section 310, causes a decreased amount of pulling on an impedance sensitive portion of XCVR section 310. One example of an impedance sensitive portion of XCVR 340 is voltage controlled oscillator (VCO) tank circuit 342. Before applying the interface signals received from modified digital interface 315 to XCVR circuitry 340, interface control block 350 converts the modified interface signals back to signals that are compatible with whatever signal standard XCVR circuitry 340 employs, for example the DigRF standard in this particular example.

Referring now to baseband IC 320 in FIG. 3, it is noted that interface control block 345 includes on-chip pads 351-358, namely an on-chip pad for each of the respective lines of modified interface 315. By the term “on-chip” pad, it is meant that the pad is situated on the integrated circuit (IC) chip which constitutes baseband IC 320. On-chip pads 351-358 are coupled to respective off-chip pads 361-368 via respective wire runners of which wire runner 359 is an example. In one embodiment, a logic high signal on a low pulling feature enable line 370 is used to turn on or enable the disclosed low pulling feature in baseband IC 320. When so enabled, interface control block 345 modifies one or more of the signals on bus 337 and provides the signals thus modified to on-chip pads 351-358 in accordance with the disclosed low pulling methodology as discussed in more detail below. Conversely, the low pulling feature may be turned off or disabled by gating enable line 370 low. In that case, interface control block 335 will pass the signals on bus 337 to on-chip pads 351-358 without modification. In other embodiments, the logic high-low convention can be inverted if desired.

Referring now to XCVR IC 325, interface control block 350 intercepts modified interface signals from modified digital interface 315. Interface control block 350 converts the modified interface signals back to the particular digital interface standard employed by XCVR circuitry 340, namely the DigRF standard in this particular example. In more detail, XCVR IC 325 includes on-chip pads 371-378, namely an on-chip pad for each of the respective lines of modified digital interface 315. On-chip pads 371-378 are coupled to respective off-chip pads 381-388 via respective wire runners of which wire runner 369 is an example. In one embodiment, a logic high signal on a low pulling feature enable line 380 is used to turn on the disclosed low pulling feature in XCVR IC 325. When so enabled, interface control block 350 modifies one or more of the signals on off-chip pads 381-388 in accordance with the disclosed low pulling methodology as discussed in more detail below. Conversely, the low pulling feature may be turned off or disabled by gating enable line 380 low. In that case, interface control block 350 will pass the signals on on-chip pads 381-388 though to XCVR circuitry 340 without modification. An eight line bus 390, including one line for each of the eight lines of digital interface 315, couples interface control block 350 to XCVR circuitry 340. Interface control block 345 and interface control block 350 are generally both enabled at the same time. In this manner, interface control block 345 converts standard interface signals to modified low pulling interface signals and interface control block 350 converts the modified low pulling interface signals back to standard interface signals.

In an alternative embodiment, it is possible that baseband circuitry 335 generates modified low pulling digital interface signals directly without employing interface control block 345 to convert standard interface signals to modify low pulling interface signals. It is also possible that XCVR 340 is configured to be compatible with modified low pulling digital interface signals. In that case, the modified low pulling digital interface signals can be supplied directly from modified interface 315 to XCVR circuitry 340 without first going through interface control block 350 for conversion back to standard interface signals. The above discussion focuses on the transmit stream, namely the scenario wherein baseband IC 320 provides information across interface 315 for XCVR IC 325 to transmit. The same low pulling technology can be applied in reverse in the receive stream, namely when XCVR IC 325 receives information and provides that information via interface 315 to baseband IC 320. In that scenario, XCVR IC 325 provides low pulling signals to baseband IC 320 at modified digital interface 315. XCVR circuitry 340 provides standard interface signals to interface control block 350 which converts them to modified low pulling interface signals that are supplied to modified digital interface 315. Interface control block 345 in baseband IC 320 receives the modified interface signals and then converts them back to standard interface signals that are compatible with baseband circuitry 335.

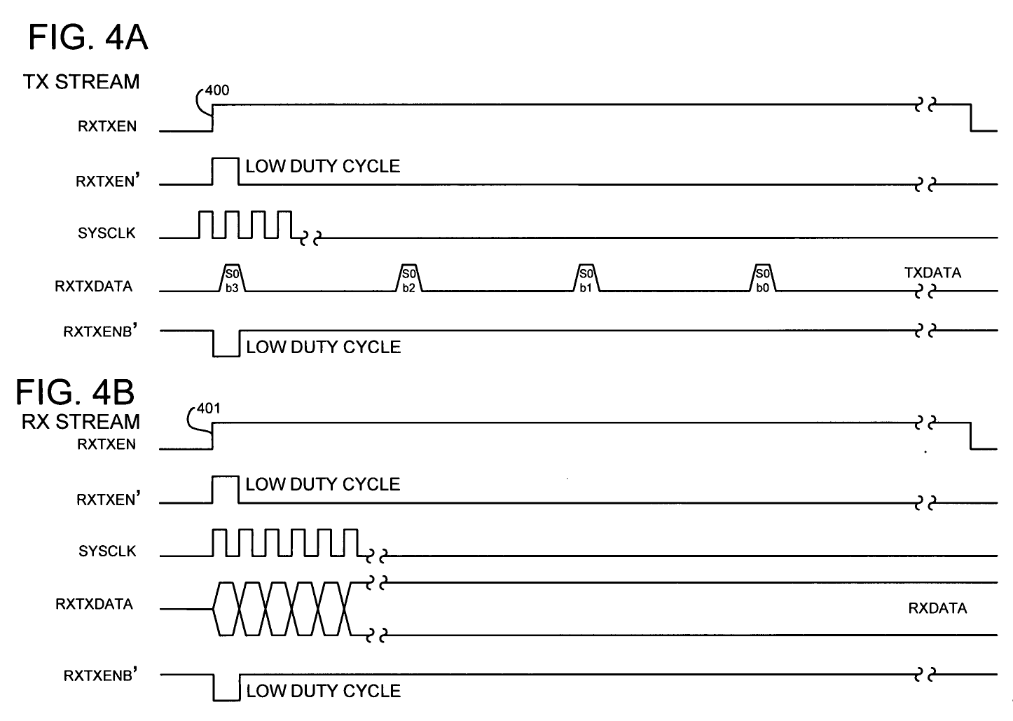

FIG. 4A shows representative transmit stream waveforms that demonstrate modification of the RXTXEN enable signal by interface control block 345 of baseband IC 320 such that XCVR IC 325 experiences low or reduced pulling of its transmit frequency. In this example, the manner in which the RXTXEN enable signal is modified to provide low pulling of the transmit frequency is discussed. The signal RXTXEN, as seen in FIG. 4A, is defined to be the unmodified or standard receive transmit enable signal generated by baseband circuitry 335. In this particular example, the RXTXEN signal conforms to the DigRF standard. The RXTXEN signal flows from the RXTXEN line of bus 337 to interface control block 345. Interface control block 345 modifies the duty cycle of the RXTXEN signal into an RXTXEN′ signal which causes low pulling. The modified RXTXEN signal is designated RXTXEN′ in the block diagram of FIG. 3 and in the waveforms of FIG. 4A. As seen in FIG. 4A, the duty cycle of the RXTXEN′ signal is substantially less than that of the RXTXEN signal depicted. Decreasing the amount of time that the RXTXEN′ signal spends in the switched or high state correspondingly reduces the amount of time that the RXTXEN′ signal can cause pulling. Interface control block 345 supplies the modified RXTXEN′ signal to on-chip pad 351. The RXTXEN′ signal flows over bond wire 359 to off-chip pad 361 which supplies the RXTXEN′ signal to the modified digital interface 315. From modified digital interface 315, the RXTXEN′ signal flows to off-chip pad 381 of XCVR IC 325. Bond wire 369 supplies the RXTXEN′ signal to on-chip pad 371. Interface control block 350 then converts the modified RXTXEN′ signal back to a standard RXTXEN signal which is compatible with XCVR circuitry 340. In this particular example, interface control block 350 converts the modified RXTXEN′ signal back to an RXTXEN signal compatible with the DigRF standard. The converted RXTXEN signal is then supplied by interface control block 350 via bus 390 to XCVR circuitry 340.

Uppermost in FIG. 4A is the unmodified RXTXEN signal from baseband circuitry 335. In this particular example, when the unmodified RXTXEN signal exhibits a logic low, there tends to be no frequency pulling exerted on VCO tank circuit 342 in XCVR circuitry 340. However, when the RXTXEN enable signal transitions to a logic high switched state at transition 400, this could cause frequency pulling in the VCO were it not for the intervention of interface control block 345 as now described. Interface control block 345 acts as a converter box which modifies signals provided thereto to lessen the likelihood that they will cause undesired pulling in XCVR IC 325 when ultimately applied thereto. In this particular example, interface control block 345 modifies the RXTXEN signal into the modified RXTXEN′ signal which exhibits a low duty cycle compared with RXTXEN signal uppermost in FIG. 4A. With such a low or small duty cycle, the RXTXEN′ enable signal tends to exhibit a small or substantially reduced amount of pulling on XCVR IC 325 in comparison with the amount of pulling that the unmodified RXTXEN enable signal would cause. It has been found that duty cycles of less than 50% for the interface signals result in a desirable decrease in pulling. The lower the value of the duty cycle of the modified RXTXEN′ signal compared with the RXTXEN signal, the lower the phase pulling becomes. Representative SYSCLK (system clock) and RXTXDATA (transmit data in this example) signals are also shown in FIG. 4A. A duty cycle of 50% in the RXTXEN signal was found to cause the maximum amount of undesired pulling. It is thus desirable that the duty cycle of the RXTXEN′ signal be other than 50%. Stated alternatively, it is desirable that the duration of the switched state, or logic high in this example, of the RXTXEN′ signal be minimized to likewise minimize undesired pulling. The duration of the switched state of RXTXEN is selected to be sufficiently small that that pulling is reduced as desired in the particular application. Pulling decreases the lower the duty cycle of the RXTXEN′ signal becomes. It is thus desirable to reduce the duration of the switched state of the RXTXEN′ signal to correspondingly reducing undesired pulling. The duty cycle of the modified RXTXEN′ signal is desirably less than the duty cycle of the RXTXEN signal. The smaller the duty cycle of the RXTXEN′ signal become, the less pulling that signal tends to exert.

In an alternative equivalent embodiment, the RXTXEN′ signal may be inverted as in the RXTXENB′ low duty cycle signal shown lowermost in FIG. 4A. RXTXENB′ is the complement of the RXTXEN′ signal. In the RXTXENB′ signal waveform, the switched state (a logic low) is again small in duration compared with the time the RXTXEN signal is high. The smaller the duration of the switched state of the RXTXEN′ or RXTXENB′ signals become, the lower or smaller the pulling becomes. The duration of the switched state of RXTXENB′ is selected to be sufficiently small that that pulling is reduced as desired in the particular application. While just one of the signal lines of digital interface 315 is modified in this embodiment, other embodiments are possible wherein the same technique is applied to modify other lines of the interface as need to reduce pulling in the particular application.

While the above discussion has concentrated on the transmit stream or TX stream, it is also possible to apply the disclosed technology in the reverse direction, namely in the receive stream or RX stream. Referring now to the receive stream of FIG. 4B and the block diagram of FIG. 3, an embodiment is discussed wherein interface control block 350 modifies the RXTXEN enable signal of the receive stream from XCVR circuitry 340. FIG. 4B shows representative receive stream waveforms that demonstrate modification of the RXTXEN enable signal by interface control block 350 of XCVR IC 325 before the RXTXEN′ signal reaches baseband IC 320. The signal RXTXEN, as seen in FIG. 4B, is defined to be the unmodified or standard receive transmit enable signal generated by XCVR circuitry 340. In this particular example, the RXTXEN signal conforms to the DigRF standard. The RXTXEN signal flows from the RXTXEN line of bus 390 to interface control block 350. Interface control block 350 modifies the duty cycle of the RXTXEN signal into an RXTXEN′ signal that exhibits a duty cycle of other than 50% or a duty cycle different from that of the RXTXEN signal. The duty cycle of the modified RXTXEN′ signal is desirably less than the duty cycle of the RXTXEN signal. The modified RXTXEN signal is designated RXTXEN′ in the block diagram of FIG. 3 and in the waveforms of FIG. 4B. As seen in FIG. 4B, the duty cycle of the RXTXEN′ signal is substantially less than that of the duty cycle of the RXTXEN signal depicted. Decreasing the amount of time that the RXTXEN′ signal spends in the switched or high state correspondingly reduces the amount of time that the RXTXEN′ signal may cause pulling in baseband IC 320 if such pulling should ever be a problem. Decreasing the amount of time that the RXTXEN′ signal spends in the switched or high state also benefits XCVR IC 325 be reducing pulling on XCVR IC 325. Interface control block 350 supplies the modified RXTXEN′ signal to on-chip pad 371. The RXTXEN′ signal flows over bond wire 369 to off-chip pad 381 which supplies the RXTXEN′ signal to the modified digital interface 315. From modified digital interface 315, the RXTXEN′ signal flows to off-chip pad 361 of baseband IC 320. Bond wire 359 supplies the RXTXEN′ signal to on-chip pad 351. Interface control block 345 then converts the modified RXTXEN′ signal back to a standard RXTXEN signal which is compatible with baseband circuitry 335. In this particular example, interface control block 345 converts the modified RXTXEN′ signal back to an RXTXEN signal compatible with the DigRF standard. The converted RXTXEN signal is then supplied by interface control block 345 via bus 337 to baseband circuitry 335.

In a manner similar to the transmit stream waveforms of FIG. 4A, the modified RXTXEN′ signal of FIG. 4B exhibits a low duty cycle when compared with the duty cycle of the RXTXEN signal which transitions at 401. The switched state (logic high) of the RXTXEN′ waveform is other than 50% and in this embodiment is substantially less than 50% of the duty cycle of the RXTXEN waveform. Likewise the switched state (logic low) of the RXTXENB′ waveform, the complement of the RXTXEN′ waveform, is substantially less then 50% of the RXTXEN waveform. The smaller the value of switched state of the RXTXEN′ or RXTXENB waveforms, the smaller the likelihood of causing pulling becomes. While just one of the signal lines of digital interface 315 is modified in this embodiment, other embodiments are possible wherein the same technique is applied to modify other lines of the interface.

FIG. 5 shows the following waveforms: the low pulling modified signal RXTXEN′, the VCO frequency and the VCO phase. The low pulling modified signal RXTXEN′ is shown uppermost in FIG. 5. The RXTXEN′ signal exhibits a low duty cycle as shown. The frequency of the VCO of transceiver 340 is shown below the RXTXEN′ signal. When the RXTXEN′ signal is low, the VCO frequency is F1. However, when the RXTXEN′ signal transitions to a logic high switched state, then for the duration of the logic high switched state, the open loop frequency of the VCO is pulled to frequency F2. In this particular representative example, the duty cycle of the RXTXEN′ signal is approximately 12%, namely a duty cycle substantially less than the 50% duty cycle at which the worst case pulling occurs. VCO phase is also depicted in FIG. 5 as the VCO phase varies from phase P1 to phase P2 as a result of the VCO frequency varying from frequency F1 to frequency F2.

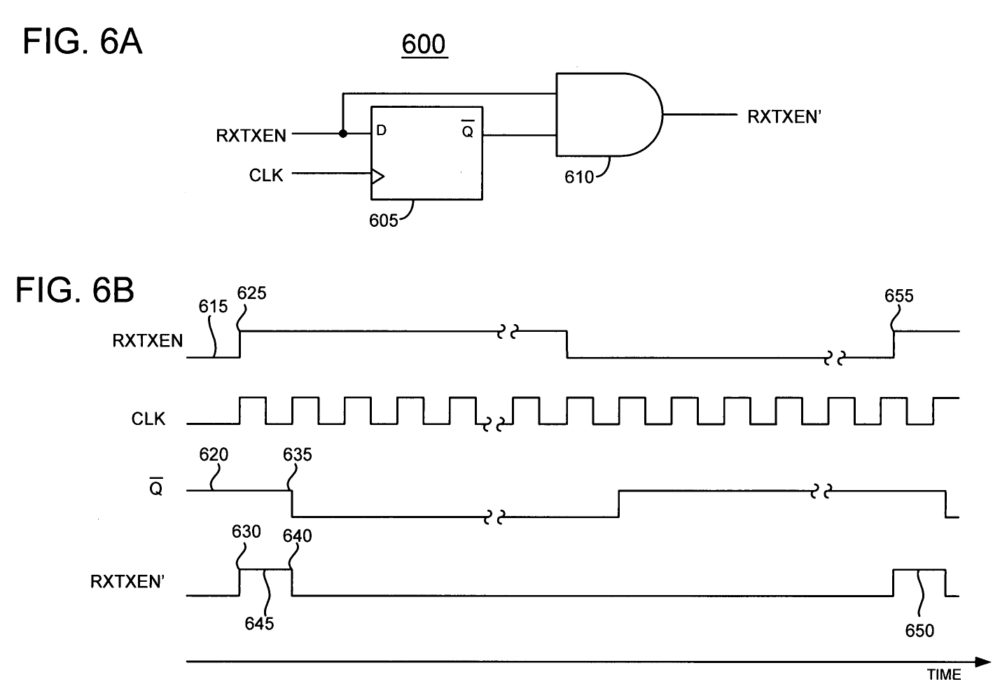

FIG. 6A is a schematic diagram of representative logic circuit 600 that can be employed in interface control block 345 to convert the RXTXEN signal to a low pulling, low duty cycle digital interface signal RXTXEN′. The same logic circuit 600 can be repeated and used to convert other signals in bus 337 to low pulling signals if desired in a particular application. Logic circuit 600 includes a flip flop 605 having a clock input to which the clock signal CLK is supplied. Flip flop 605 also includes a D input to which the RXTXEN signal is supplied. Flip flop 605 further includes a /Q output which is coupled to one input of a two input AND gate 610. The D input of flip flop 605 is coupled to the remaining input of AND gate 610 such that the RXTXEN signal is supplied thereto. The modified RXTXEN′ signal is generated at the output of AND gate 610.

FIG. 6B shows RXTXEN, CLK, /Q and RXTXEN′ waveforms to depict how interface control block 345 converts the RXTXEN signal to a low pulling, low duty cycle digital interface signal RXTXEN′. RXTXEN is the enable signal before conversion and RXTXEN′ is the enable signal after conversion. Assume that RXTXEN is low, as at 615, and that RXTXEN has been clocked into flip flop 605 such that the /Q output is high, as at 620. Thus, when RXTXEN transitions high at 625, both inputs of AND gate 610 are now high such that the RXTXEN′ signal at the output of AND gate 610 also goes high at 630. On the next clock cycle of clock signal CLK, the RXTXEN signal at the D input of flip flop 605 is high, such that the /Q output of flip flop 605 goes low at 635. Thus, a logic high and a logic low are supplied to the inputs of AND gate 610, and consequently the RXTXEN′ signal goes low at 640. A low duty cycle RXTXEN′ pulse 645 is thus generated at the output of AND gate 610. It can be seen by inspection that the duty cycle of the RXTXEN′ pulse signal is less than the duty cycle of RXTXEN signal. The lower the duty cycle of the RXTXEN′ signal, the lower is the pulling that the RXTXEN′ can exert on the VCO tank circuit 342 of XCVR circuitry 340. As seen in FIG. 6B, another pulse 650 of the RXTEXN′ signal does not occur until RXTXEN exhibits another rising edge such as at 655.

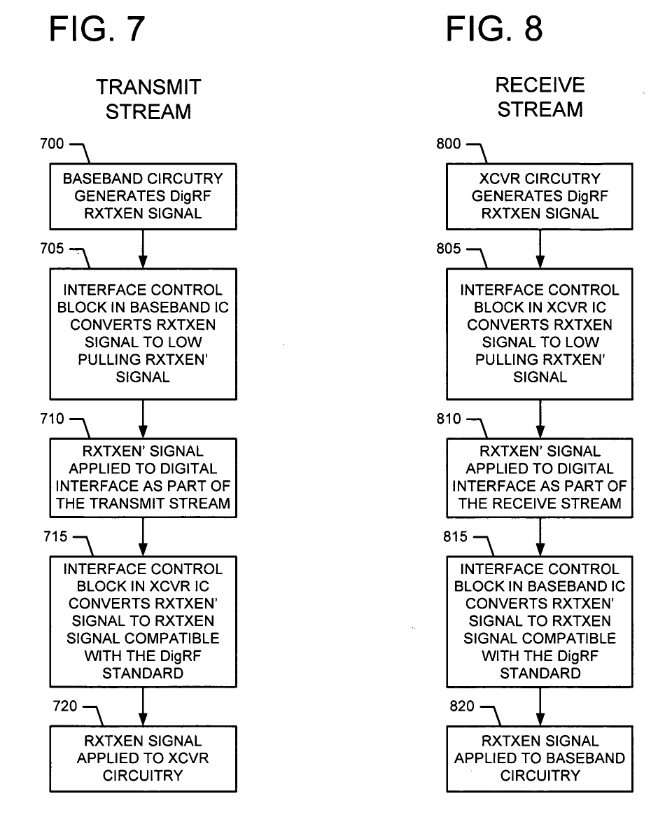

FIG. 7 is a flowchart depicting process flow when wireless communication device 300 is operative in a transmit mode wherein baseband section 305 sends a transmit stream to XCVR section 310. Baseband circuitry 335 generates an RFTXEN signal which is compatible with a standard such as the DigRF standard, as per block 700. Such a signal could cause pulling in XCVR circuitry 340 of XCVR IC 325 if allowed to reach XCVR circuitry 340 without modification. Interface control block 345 modifies or converts the RXTXEN signal to an RXTXEN′ signal with a reduced duty cycle, as per block 705. Interface control block 345 modifies the duty cycle of the RXTXEN signal such that the duty cycle of the RXTXEN′ signal is less than the duty cycle of the RXTXEN signal. In some applications, the duty of the cycle of the RXTXEN′ signal may be substantially less than the duty cycle of the RXTXEN signal and may be substantially less than 50%. The smaller the duty cycle of the RXTXEN′ signal, the smaller the pulling the RXTXEN′ signal exerts on XCVR circuitry 340 becomes. In one embodiment, interface control block 345 modifies the duty cycle of the RXTXEN signal such that the duty cycle is less then 50%, namely the duty cycle that results in worst case pulling. It is understood that inverted logic may be applied to the RXTXEN and RXTXEN′ signals. In that scenario, the RXTXEN′ signal may be high for a longer period of time than a low switched state. However, such an inverted logic RXTXEN′ signal is still considered to be a low duty cycle signal if the switched state of the RXTXEN′ signal, namely a logic low in this example, occurs for less than the amount of time that the RXTXEN′ signal is high. The RXTXEN′ signal is supplied to modified digital interface 315 by baseband IC 320, as per block 710. This RXTXEN′ signal is off-chip at interface 315. In accordance with the above discussion, the RXTXEN′ signal exhibits a reduced duty cycle that causes less pulling than if the RXTXEN signal were applied to XCVR IC 325 without modification. The modified RXTXEN′ signal is then supplied to interface control block 350 which converts the RXTXEN′ signal to an RXTXEN signal compatible with whatever interface standard XCVR circuitry 340 employs, as per block 715. The RXTXEN signal is then supplied to XCVR circuitry 340, as per block 720 In response, less pulling of the VCO/tank circuit 342 will occur with the reduced duty cycle signal RXTXEN′ than if the RXTXEN signal were applied to XCVR IC 325. While the process described in the flowchart of FIG. 7 applies to modification of the RFTXEN signal, the same process can be applied to other signals in the transmit stream as needed according to the particular application.

FIG. 8 is a flowchart depicting process flow when wireless communication device 300 is operative in a receive mode wherein XCVR section 310 sends a receive stream to baseband section 305. XCVR circuitry 340 generates an RFTXEN signal which is compatible with a standard such as the DigRF standard, as per block 800. Interface control block 350 modifies or converts the RXTXEN signal to an RXTXEN′ signal with a reduced duty cycle, as per block 805. Interface control block 350 modifies the duty cycle of the RXTXEN signal such that the duty cycle of the result modified RXTXEN signal is smaller than the duty cycle of the RXTXEN signal. In one embodiment, interface control block 350 modifies the duty cycle of the RXTXEN signal such that the duty cycle is less then 50%. The RXTXEN′ signal is then supplied to modified digital interface 315 by XCVR IC 325 as part of the receive receive stream, as per block 810. This RXTXEN′ signal is off-chip at interface 315. The modified RXTXEN′ signal is then supplied by interface 315 to interface control block 345 that modifies the RXTXEN′ signal back to a signal RXTXEN which is compatible with the DigRF standard in this embodiment, as per block 815. The resultant RXTXEN signal is then supplied to baseband circuitry 335, as per block 820. While the process described in the flowchart of FIG. 8 applies to modification of the RFTXEN signal, the same process can be applied to other signals in the receive stream as needed according to the particular application.

In an alternative embodiment, interface control block 345 in baseband IC 320 is not necessary if baseband circuitry 335 is configured to generate low pulling signals such as RXTXEN′ directly without modification. Likewise, interface control block 350 of XCVR IC 325 is not necessary if XCVR circuitry 340 is compatible with low pulling signals generated by baseband IC 320.

A wireless communication device is thus disclosed which modifies signals on the interface between the baseband and transceiver sections of the device to reduce the duty cycle of one or more of such signals. In other words, the duty cycle of signals on the off-chip interface, namely the external or modified interface, are reduced. In this manner, undesired pulling effects within the wireless device are likewise decreased.

Modifications and alternative embodiments of this invention will be apparent to those skilled in the art in view of this description of the invention. Accordingly, this description teaches those skilled in the art the manner of carrying out the invention and is to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of operating a wireless communication device including a baseband IC and a radio frequency (RF) IC comprising:
coupling, by a digital interface, the baseband IC to the RF IC; and
sending, by the baseband IC, a low duty cycle signal across the digital interface to the RF IC, such that low pulling of an impedance sensitive portion of the RF IC is achieved.

2. The method of claim 1 wherein the duty cycle of the low duty cycle signal is other than 50%.

3. The method of claim 1, wherein the impedance sensitive portion is a variable frequency oscillator (VCO).

4. The method of claim 1, further comprising modifying, by a baseband interface control block in the baseband IC, a first baseband signal exhibiting a first duty cycle compatible with baseband circuitry in the baseband IC to become a second baseband signal which is the low duty cycle signal.

5. The method of claim 4, wherein the first baseband signal conforms to the DigRF standard.

6. The method of claim 4, wherein the low duty cycle exhibited by the second baseband signal is less than the first duty cycle of the first baseband signal.

7. The method of claim 1, further comprising modifying, by an RF interface control block in the RF IC, the low duty cycle signal of the digital interface to become an RF signal exhibiting a duty cycle compatible with RF circuitry in the RF IC.

8. The method of claim 7, wherein the RF interface signal conforms to the DigRF standard.

9. The method of claim 7, wherein the duty cycle of the low duty cycle signal is less than the duty cycle of the RF interface signal.

10. A method of operating a wireless communication device including a baseband IC and a radio frequency (RF) IC comprising:
coupling, by a digital interface, the RF IC to the baseband IC; and
sending, by the RF IC, a low duty cycle signal across the digital interface to the baseband IC, such that low pulling of an impedance sensitive portion of the RF IC is achieved.

11. The method of claim 10 wherein the duty cycle of the low duty cycle signal is other than 50%.

12. The method of claim 10, wherein the impedance sensitive portion is a variable frequency oscillator (VCO).

13. The method of claim 10, further comprising modifying, by an RF interface control block in the RF IC, a first RF signal exhibiting a first duty cycle compatible with RF circuitry in the RF IC to become a second RF signal which is the low duty cycle signal.

14. The method of claim 13, wherein the first RF signal conforms to the DigRF standard.

15. The method of claim 13, wherein the low duty cycle exhibited by the second RF signal is less than the first duty cycle of the first RF signal.

16. The method of claim 10, further comprising modifying, by a baseband interface control block in the baseband IC, the low duty cycle signal of the digital interface to become an baseband signal exhibiting a duty cycle compatible with baseband circuitry in the baseband IC.

17. The method of claim 16, wherein the baseband signal conforms to the DigRF standard.

18. The method of claim 16, wherein the duty cycle of the low duty cycle signal is less than the duty cycle of the baseband signal.

19. A wireless communication device comprising:
a baseband section;
a radio frequency (RF) section including an impedance sensitive portion; and
a digital interface that couples the baseband section to the RF section;
wherein the baseband section sends a low duty cycle signal across the digital interface to the RF section such that low pulling of the impedance sensitive portion in the RF section is achieved.

20. The wireless communication device of claim 19 wherein the duty cycle of the low duty cycle signal is other than 50%.

21. The wireless communication device of claim 19, wherein the impedance sensitive portion is a variable frequency oscillator (VCO).

22. The wireless communication device of claim 19, wherein the baseband section further comprises:
baseband circuitry that generates a baseband signal exhibiting a duty cycle; and
a baseband interface control block, coupled to the baseband circuitry, that generates the low duty cycle signal from the baseband signal.

23. The wireless communication device of claim 22, wherein the baseband signal conforms to the DigRF standard.

24. The wireless communication device of claim 22, wherein the duty cycle of the low duty cycle signal is less than the duty cycle of the baseband signal.

25. The wireless communication device of claim 19, wherein the RF section further comprises:
RF circuitry in which the impedance sensitive portion is situated; and
an RF interface control block, coupled to the digital interface and the RF circuitry, that converts the low duty cycle signal to an RF circuitry signal exhibiting a duty cycle compatible with the RF circuitry.

26. The wireless communication device of claim 25, wherein the RF circuitry signal conforms to the DigRF standard.

27. The wireless communication device of claim 25, wherein the duty cycle of the low duty cycle signal is less than the duty cycle of the RF circuitry signal.

28. A wireless communication device comprising:
a baseband section;
a radio frequency (RF) section including an impedance sensitive portion; and
a digital interface that couples the baseband section to the RF section;
wherein the RF section sends a low duty cycle signal across the digital interface to the baseband section such that low pulling of the impedance sensitive portion in the RF section is achieved.

29. The wireless communication device of claim 28 wherein the duty cycle of the low duty cycle signal is other than 50%.

30. The wireless communication device of claim 28, wherein the impedance sensitive portion is a variable frequency oscillator (VCO).

31. The wireless communication device of claim 28, wherein the RF section further comprises:
RF circuitry that generates an RF signal exhibiting a duty cycle; and
an RF interface control block, coupled to the RF circuitry, that generates the low duty cycle signal from the RF signal.

32. The wireless communication device of claim 31, wherein the RF signal conforms to the DigRF standard.

33. The wireless communication device of claim 31, wherein the duty cycle of the low duty cycle signal is less than the duty cycle of the RF signal.

34. The wireless communication device of claim 28, wherein the baseband section further comprises:
baseband circuitry; and
a baseband interface control block, coupled to the digital interface and the baseband circuitry, that converts the low duty cycle signal to a baseband signal exhibiting a duty cycle compatible with the baseband circuitry.

35. The wireless communication device of claim 34, wherein the baseband circuitry signal conforms to the DigRF standard.

36. A wireless communication device comprising:
a baseband integrated circuit (IC);
a radio frequency (RF) IC including impedance sensitive RF circuitry;
a digital interface, external to the baseband IC and the RF IC, that couples the baseband IC to the RF IC;
wherein the baseband section sends a low duty cycle signal across the digital interface to the RF IC such that low pulling of the impedance sensitive RF circuitry is achieved.

37. The wireless communication device of claim 36 wherein the baseband IC further comprises:
baseband circuitry that generates a baseband signal exhibiting a duty cycle; and
a baseband interface control block, coupled to the baseband circuitry, that generates the low duty cycle signal from the baseband signal.

38. The wireless communication device of claim 37, wherein the duty cycle of the low duty cycle signal is less than the duty cycle of the baseband signal.

39. The wireless communication device of claim 36, wherein the RF IC includes an RF interface control block, coupled to the digital interface and the impedance sensitive RF circuitry, that converts the low duty cycle signal to an RF circuitry signal exhibiting a duty cycle compatible with the RF circuitry.

40. The wireless communication device of claim 39, wherein the duty cycle of the low duty cycle signal is less than the duty cycle of the RF circuitry signal.

41. The wireless communication device of claim 36 wherein the duty cycle of the low duty cycle signal is other than 50%.

42. A method of operating a wireless communication device including a baseband IC and a radio frequency (RF) IC comprising:
coupling, by a digital interface, the baseband IC to the RF IC; and
sending, by the baseband IC, an interface signal across the digital interface to the RF IC, the interface signal exhibiting a switched state that is sufficiently short in time that significant pulling of an impedance sensitive portion of the RF IC is avoided.

43. The method of claim 42, wherein the impedance sensitive portion is a variable frequency oscillator (VCO).
